(19) United States
(12) Patent Application Publication
(10) Pub. No.: US 2024/0254312 A1
(43) Pub. Date: Aug. 1, 2024

(54) ODOUR NEUTRALISING COMPOSITION

(71) Applicant: QUARZWERKE GmbH, Frechen (DE)

(72) Inventors: Erdem SENOL, Grenzach-Whylen (DE); Thorsten HILGERS, Kerpen (DE); Olaf MÜHLING, Bergheim-Thorr (DE); Dirk KRUBER, Alfter (DE)

(21) Appl. No.: 18/564,586

(22) PCT Filed: May 27, 2022
(86) PCT No.: PCT/EP2022/064387

§ 371 Date: Nov. 28, 2023

(30) Foreign Application Priority Data
May 28, 2021 (EP) 21176476.6

(51) Int. Cl. C08K 3/34; C08K 9/06

(52) U.S. Cl. CPC C08K 3/34; C08K 9/06; C08K 2003/343; C08K 2201/006

(57) ABSTRACT

The invention relates to a composition comprising a) plastic material and other substances, b) odour neutraliser comprising calcium silicate hydrate, c) polysaccharide, d) adhesion promoter.

The present invention relates to a composition comprising an odor neutralizer, a process for preparing the composition, and the use of the odor neutralizer.

Apart of haptics, odor is a factor essential to the success of consumer products. If a material or component made of plastic, for example, in the interior of a motor vehicle, has a subjectively unpleasant odor, this may adversely affect the purchase decision. In addition, numerous plastic products have to meet strict demands with respect to the emission of chemical substances. Therefore, it is in the interest of plastic processors and compounders to reduce odorous emission of plastics as much as possible.

The causes for the occurrence of odors are many. Often, it is not the plastic itself that is responsible for the odor, but residual amounts of low-molecular substances that remain from the preparation of the plastic. Additives, such as processing aids, stabilizers, fibers or fillers, which are admixed with the plastic when a material is manufactured, may also cause disturbing odors. In addition, the production and further processing of plastic-containing materials also produces substances that may lead to disturbing odors, for example, as a consequence of thermal decomposition.

The risk of odor emissions is even enhanced if recycled plastics, or a mixture of virgin and recycled materials, rather than all-virgin plastic materials are used as the starting material. Plastic materials recycled from post-consumer waste contain odorants, which often cannot be removed completely in the processing. Packaging waste often includes typical metabolic products of microorganisms that generate a cheesy and fecal odor.

There have been many attempts to reduce the odor of plastic parts. Thus, for example, WO 2017/060171 describes the use of an inorganic additive, especially a silicate material. Diatomaceous earth and calcium silicates are explicitly mentioned.

There is further a need for alternatives for reducing odors in plastics, which are possibly superior to the known options in some aspects.

It has been the object of the present invention to provide corresponding methods and products.

This object is achieved by a composition comprising a material made of plastic and further ingredients, and an odor neutralizer comprising calcium silicate hydrate.

In principle, all kinds of plastics may be employed as said plastics. Particularly suitable are plastics selected from the group consisting of polyolefins, especially polyethylenes and their copolymers and modifications, polypropylenes and their copolymers, polybutynes, polyisobutylenes, polymethylpentenes, and cycloolefin copolymers, poly(vinyl chlorides) and poly(vinyl chloride) modifications, styrene homopolymers and styrene copolymers, polyacrylates, especially polyacrylonitriles and their copolymers, and poly(methyl methacrylates) and their copolymers and blends, polyacetals, fluoroplastics, polyamides, thermoplastic polyesters, especially polycarbonates, poly(ethylene terephthalates), poly(butylene terephthalates), polyarylsulfones and polyarylsulfides, polyetherketones, polyimides, and copolyimides, thermosetting polycondensates, especially phenol resins, urea/formaldehyde plastics, melamine/formaldehyde plastics, unsaturated polyester resins, alkyde resins, and silicones, thermosetting polyadducts, especially epoxy resins, polyurethanes, especially cross-linked polyurethanes, and thermoplastic polyurethane elastomers, elastomeric polymers, especially natural rubbers, butadiene rubbers, styrene-butadiene rubbers, chlorobutadiene rubbers, acrylonitrile-butadiene rubbers, hydrogenated acrylonitrile-butadiene rubbers, ethylene-propylene-diene rubbers, butyl rubbers, ethylene oxide-epichlorohydrin rubbers, acrylate rubbers, ethylene acrylate rubbers, fluororubbers, and perfluororubbers, biopolymers, especially polylactic acids, celluloses and cellulose derivatives, lignin-based thermoplasts, thermosetting materials based on renewable raw materials, and natural fiber composites, and mixtures thereof.

The composition according to the invention always relates to plastics that contain further ingredients. The combination of plastics and further ingredients is referred to as a “material”. Typical further ingredients include, in particular, ingredients from the group consisting of fillers, especially mineral fillers, inorganic and organic fibers, plastic additives including lubricants, antiblocking agents, release agents, antioxidants, light protecting agents, thermal stabilizers, foam stabilizers, antistatic agents, antifogging additives, slip additives, flame retardants, colorants, effect pigments, optical brighteners, additives for laser marking, impact modifiers, softeners, adhesion promoters, propellants, nucleating agents, clarifiers, acid scavengers, antibacterial additives, antiviral additives, and fungicides, contaminants resulting from the production, preparation, further processing and utilization of the material, and mixtures thereof.

In a preferred embodiment of the invention, the plastic or preferably the material is wholly or partially made of recycled plastics.

Recycled plastics may be pure type, pure grade, similar grade, mixed, or contaminated. “Pure type” means that only one plastic from one raw material manufacturer with the same type designation is being processed.

“Pure grade” means that plastics with the same designation according to DIN EN ISO 11469 or VDA 260 are being processed, but which may originate from different manufacturers. “Similar grade” plastics are identical in the processing of their basic polymers, but have different properties (e.g., flame-retardant additives).

“Mixed” means that different plastics having chemical compatibility are being processed. They are said to be compatible only if they can be mixed homogeneously in the melting process and can be processed into a shaped fabric with satisfying mechanical properties and an acceptable surface finish.

“Contaminated” means that the plastics to be processed contain other materials that adversely affect the properties of a shaped part to be made therefrom. Such contaminated plastics mostly originate from household and commercial waste.

The odor neutralization is achieved by an odor neutralizer that includes calcium silicate hydrate. Calcium silicate hydrates (CSH) include both natural and synthetic minerals, for example, xonotlite. From a formal point of view, calcium silicate hydrates are hydration products of calcium silicates. They are typically characterized by the molar ratio of CaO to SiO₂ (C/S ratio). In this calculation, the water content remains unconsidered for the characterization. Preferably, said calcium silicate hydrates are crystalline calcium silicate hydrates.

### Typical Known Calcium Silicate Hydrates are

a) nesosubsilicates (orthosilicates with further anions), such as afwillite, bultfonteinite, α-C₂SH, and reinhardbraunsite,
b) sorosilicates, such as dellaite, killalaite, jaffeite, kilchoanite and C₈S₅,
c) inosilicates (chain silicates), such as tobermorite, klinotobermorite, jennite, xonotlite, foshagite, and hillebrandite,
d) mixed sheet and chain silicates, such as okenite,
e) phyllosilicates (sheet silicates), such as nekoite, truscottite, K phase and Z phase, and sheet silicates with (CO3) groups, such as scawtite, fukalite, tylleite, and spurrite.
   It has been found preferable for the calcium silicate hydrate to have a BET specific surface of at least 20 m²/g, preferably at least 30 m²/g. Preferably, the BET specific surface should be at most 800 m²/g, preferably <50 m²/g.

Particularly preferred calcium silicate hydrates include xonotlites and tobermorites, and mixtures thereof.

Preferably, the C/S ratio is within a range of from 0.6 to 1.4, more preferably from 0.8 to 1.2.

In a preferred embodiment, the odor neutralizer additionally comprises a polysaccharide and/or adhesion promoter.

### Preferably, Said Polysaccharide has One of the Following Properties:

a) said polysaccharide has at least partially a helical structure,
b) said polysaccharide has an average molecular weight of more than 10,000 g/mol, especially more than 100,000 g/mol, and/or
c) said polysaccharide is starch, a starch derivative, or a mixture thereof.
   Suitable polysaccharides include, for example, native tapioca starch, waxy maize starch (each from FH Diedrichs & Ludwig Post GmbH), Nastar pea starch (from Georg Breuer GmbH), AmyloGel 03003 native starch (from Cargill), Emwaxy 100, and Emfloc KC 750 (each from Emsland-Stärke GmbH), or mixtures thereof.

Suitable adhesion promoters include, in particular, compounds that are functional silanes. Preferably, at least one alkoxy group is bonded to each silicon atom of said functional silane. In addition, said functional silane may comprise amino, alkyl, epoxy, alkoxy, alkenyl, alkynyl, aryl, fluoroalkyl, carbonyl, carboxy, hydroxy, acryl and/or methacryl groups. Preferred adhesion promoters include tetramethyl orthosilicate (TMOS) or tetraethyl orthosilicate (TEOS), or mixtures thereof.

Preferably, said odor neutralizer is contained in an amount that is suitable for reducing the odor according to VDA 270 by at least 0.5 units, preferably by at least 1.0 unit, especially by at least 1.5 units.

A typical composition according to the invention is a composition containing
a) 10.0 to 99.9% by weight of material including
   i) 20.0 to 99.9% by weight of plastic,
   ii) 0.1 to 80.0% by weight of further ingredients,
b) 0.1 to 90.0% by weight of odor neutralizer, comprising
   iii) 50.0 to 100% by weight of calcium silicate hydrate,
   iv) 0 to 50.0% by weight of polysaccharide,
   v) 0 to 10.0% by weight of adhesion promoter,
      in which the weight percentages a) and b), i) and ii), and iii) to v), respectively sum up to 100% by weight each. Preferably, the plastic or preferably the material is wholly or partially made of recycled plastics.

Another typical composition according to the invention is a composition containing
a) 10.0 to 99.9% by weight of material including
   i) 20.0 to 99.9% by weight of plastic,
   ii) 0.1 to 80.0% by weight of further ingredients,
b) 0.1 to 90.0% by weight of odor neutralizer, comprising
   iii) 50.0 to 99.8% by weight of calcium silicate hydrate,
   iv) 0.1 to 50.0% by weight of polysaccharide,
   v) 0.1 to 10.0% by weight of adhesion promoter,
      in which the weight percentages a) and b), i) and ii), and iii) to v), respectively sum up to 100% by weight each.

In cases in which the odor neutralizer is contained in a very large amount, the composition acts as a masterbatch, which can be mixed with plastic for application.

In other embodiments, the composition defines a suitable end product. For a typical masterbatch, the content of material is from 10 to 50% by weight, and the content of odor neutralizer is accordingly from 50 to 90% by weight.

For an end product, the composition typically contains from 50 to 99.9% of material, and from 0.1 to 50% by weight of odor neutralizer.

In preferred embodiments, an end product contains at least 3 or at least 5 or at least 10% by weight of odor neutralizer.

In preferred embodiments, the adhesion promoter is bonded to the calcium silicate hydrate.

The invention also relates to a process for producing the composition according to the invention, comprising the step of melt-mixing the odor neutralizer with molding compounds of materials made of plastic and other ingredients in an extruder or kneader.

In a preferred embodiment of the process, the components of the odor neutralizer are directly mixed or homogeneously premixed with the material. Preferably, the adhesion promoter is applied to the calcium silicate hydrate first.

The invention also relates to the use of an odor neutralizer comprising calcium silicate hydrate for the odor neutralization of materials that comprise plastics, recycled plastics, or mixtures thereof, especially wherein optionally said odor neutralizer additionally comprises a polysaccharide and/or adhesion promoter.

### THE INVENTION IS FURTHER ILLUSTRATED BY MEANS OF THE FOLLOWING EXAMPLES

### Mechanical and Thermal Test Methods for Test Specimens Made of the Material

Tensile modulus Et according to DIN EN ISO 527-1 &-2
Charpy impact strength (unnotched) a_{c}U according to DIN EN ISO 179-1 &-2
heat deflection temperature Tfr 0.45 according to DIN EN ISO 75-1 &-2, method B (bending stress 0.45 MPa)
   Odor Test with Test Specimens Made of the Material

The odor characteristics were tested according to VDA 270 variant B4 by 3 to 6 trained subjects.

Each subject evaluates the odor according to the following scale:
1=odor is not perceptible
2=odor is perceptible, but not disturbing
3=odor is clearly perceptible, but not disturbing
4=odor is disturbing
5=odor is very much disturbing
6=odor is unbearable

### Materials Employed

Calcium silicate hydrate having the following properties:
Xonotlite
C/S ratio=1:1
Bulk density (DIN EN ISO 787-10): 0.14 g/cm3
Specific surface area (DIN ISO 9277): 38 m²/g
Density (DIN EN ISO 787-10): 2.62 g/ml
Ignition loss at 1000° C. (DIN EN ISO 3262-1): 6%

### Polysaccharides

Four starch types that differ in the weight proportions of amylose to amylopectin as follows:
a) 20% amylose, 80% amylopectin
b) 55% amylose, 45% amylopectin
c) 70% amylose, 30% amylopectin
d) 1% amylose, 99% amylopectin

### Adhesion Promoter

Tetraethyl orthosilicate (TEOS)

### Plastic

SYSTALEN 13404 gr 002-PP (recycled polypropylene from the Grüner Punkt)
MFI (DIN EN ISO 1133): 12 g/10 min at 230° C./2.16 kg

### Experimental Procedures

Preparation of Odor Neutralizers from Calcium Silicate Hydrate and Polysaccharide and/or Adhesion Promotor:

2 kg of calcium silicate hydrate is charged in a laboratory Henschel mixer (10 l volume), and admixed with the respective amount of adhesion promoter and/or polysaccaride. The weight proportions can be seen from Table 1, Examples 2 to 8. The two- or three-component mixture was processed at 2000 rpm and a shell temperature of 90° C. until a compound temperature of 80° C. was reached.

Preparation of Compounds from Odor Neutralizer and Plastic

The plastic and the odor neutralizer were molten and mixed in a dual-screw extruder (Coperion ZSK18) according to the following conditions:
Temperatures zones 1-7=200° C.-220° C.
Nozzle temperature=230° C.
Screw speed=600 rpm
Mass flow rate=10 kg/h

The resulting compound strand was cooled through a water bath and cut into pellets. The odor neutralizer was metered gravimetrically through the side feeder into the plastic melt. The weight proportions of plastic and odor neutralizer can be seen from Table 1, Examples 1 to 8.

### Preparation of Test Specimens

The compounds were molded into test specimens in an injection-molding machine (Engel Victory 200/50) (temperature 220° C. in all 4 heating zones).

Test specimens of type 1A (DIN EN ISO 527-2) were molded for determining the tensile modulus. The type 1A test specimens were cut into type 1 test specimens (according to DIN EN ISO 179-1) for determining the Charpy impact strength and heat deflection temperature. For the odor test according to VDA 270, small plates of type D2 were molded according to DIN EN ISO 294-3.

TABLE 1

| Example | | 1 | 2 | 3 | 4 | 5 | 6 | 7 | 8 | 9 |
|---|---|---|---|---|---|---|---|---|---|---|
| Plastic | [% by | 95 | 95 | 95 | 95 | 95 | 95 | 95 | 95 | 100 |
| | weight] | | | | | | | | | |
| Calcium silicate | [% by | 5.00 | 4.96 | 3.55 | 3.55 | 3.55 | 3.55 | 3.57 | — | — |
| hydrate | weight] | | | | | | | | | |
| Polysaccharide | *type | — | — | a | b | c | d | c | c | — |
| | [% by | — | — | 1.42 | 1.42 | 1.42 | 1.42 | 1.43 | 5.00 | |
| | weight] | | | | | | | | | |
| Adhesion | [% by | — | 0.04 | 0.03 | 0.03 | 0.03 | 0.03 | — | — | — |
| promoter | weight] | | | | | | | | | |
| Tensile modulus | [MPa] | 1360 | 1330 | 1330 | 1380 | 1360 | 1320 | 1380 | 1300 | 1250 |
| Eₜ | | | | | | | | | | |
| Charpy impact | [kJ/m₂] | 65 | 62 | 64 | 83 | 71 | 77 | 69 | 41 | 77 |
| strength a_{cU} | | | | | | | | | | |
| Heat deflection | [° C.] | 102 | 98 | 97 | 96 | 100 | 102 | 98 | 104 | 95 |
| temperature T_{ff} | | | | | | | | | | |
| 0.45 | | | | | | | | | | |
| Odor | | 2.6 | 2.3 | 2.3 | 2.5 | 3.0 | 3.0 | 2.8 | 4.1 | 4.1 |
| characteristics | | | | | | | | | | |

*Polysaccharide type:
a = 20% amylose + 80% amylopectin;
b = 55% amylose + 45% amylopectin;
c = 70% amylose + 30% amylopectin;
d = 1% amylose + 99% amylopectin

1. A composition comprising
a) a material made of plastic and other ingredients,
b) an odor neutralizer comprising calcium silicate hydrate,
c) a polysaccharide,
d) an adhesion promoter.

2. The composition according to claim 1, wherein said odor neutralizer is contained in an amount that is suitable for reducing the odor according to VDA 270 by at least 0.5 units.

3. The composition according to claim 1,
containing
a) 10.0 to 99.9% by weight of material including
i) 20.0 to 99.9% by weight of plastic,
ii) 0.1 to 80.0% by weight of other ingredients,
b) 0.1 to 90.0% by weight of odor neutralizer, comprising
iii) 50.0 to 99.8% by weight of calcium silicate hydrate,
iv) 0.1 to 50.0% by weight of polysaccharide,
v) 0.1 to 10.0% by weight of adhesion promoter,
in which the weight percentages a) and b), i) and ii), and iii) to v), respectively sum up to 100% by weight each.

4. The composition according to claim 1, wherein the plastic is selected from the group consisting of
a) polyolefins,
b) poly(vinyl chlorides) and poly(vinyl chloride) modifications,
c) styrene homopolymers and styrene copolymers,
d) polyacrylates,
e) polyacetals,
f) fluoroplastics,
g) polyamides,
h) thermoplastic polyesters,
i) thermosetting polycondensates,
j) thermosetting polyadducts,
k) polyurethanes,
l) elastomeric polymers,
m) biopolymers,
and mixtures thereof.

5. The composition according to claim 1, wherein said plastic or material is made partially or completely of recycled plastics.

6. The composition according to claim 1, wherein said other ingredients of the material are selected from the group consisting of
a) fillers, especially mineral fillers,
b) inorganic and organic fibers,
c) plastic additives including lubricants, antiblocking agents, release agents, antioxidants, light protecting agents, thermal stabilizers, foam stabilizers, antistatic agents, antifogging additives, slip additives, flame retardants, colorants, effect pigments, optical brighteners, additives for laser marking, impact modifiers, softeners, adhesion promoters, propellants, nucleating agents, clarifiers, acid scavengers, antibacterial additives, antiviral additives, and fungicides,
d) contaminants resulting from the production, preparation, further processing and utilization of the material,
and mixtures thereof.

7. The composition according to claim 3, wherein said calcium silicate hydrate has a BET specific surface area of ≥20 m²/g and wherein said calcium silicate hydrate has a BET specific surface area of ≤800 m²/g.

8. The composition according to claim 3, wherein said calcium silicate hydrate is selected from the group consisting of the crystalline calcium silicate hydrates, xonotlites and tobermorites, and mixtures thereof.

9. The composition according to claim 3, wherein said polysaccharide has a property selected from the group of
a) said polysaccharide has at least partially a helical structure,
b) said polysaccharide has an average molecular weight of more than 10,000 g/mol, and
c) said polysaccharide is starch, a starch derivative, or a mixture thereof.

10. The composition according to claim 1, wherein said adhesion promoter is a functional silane having at least one alkoxy group at each silicon atom.

11. The composition according to claim 3, wherein the adhesion promoter is bonded to the calcium silicate hydrate.

12. A composition comprising
a) a material made of plastic and other ingredients,
b) an odor neutralizer comprising calcium silicate hydrate, wherein said plastic or material is made partially or completely of recycled plastics.

13. The composition according to claim 12, wherein said odor neutralizer additionally comprises
a polysaccharide and/or
an adhesion promoter.

14. The composition according to claim 12, wherein said odor neutralizer is contained in an amount that is suitable for reducing the odor according to VDA 270 by at least 0.5 units.

15. The composition according to claim 12, containing
a) 10.0 to 99.9% by weight of material including
i) 20.0 to 99.9% by weight of plastic,
ii) 0.1 to 80.0% by weight of other ingredients,
b) 0.1 to 90.0% by weight of odor neutralizer, comprising
iii) 50.0 to 100% by weight of calcium silicate hydrate,
iv) 0 to 50.0% by weight of polysaccharide,
v) 0 to 10.0% by weight of adhesion promoter,
in which the weight percentages a) and b), i) and ii), and iii) to v), respectively sum up to 100% by weight each.

16. The composition according to claim 12, wherein the plastic is selected from the group consisting of
a) polyolefins,
b) poly(vinyl chlorides) and poly(vinyl chloride) modifications,
c) styrene homopolymers and styrene copolymers,
d) polyacrylates,
c) polyacetals,
f) fluoroplastics,
g) polyamides,
h) thermoplastic polyesters,
i) thermosetting polycondensates,
j) thermosetting polyadducts,
k) polyurethanes,
l) elastomeric polymers,
m) biopolymers,
and mixtures thereof.

17. The composition according to claim 12, wherein said other ingredients of the material are selected from the group consisting of
a) fillers,
b) inorganic and organic fibers,
c) plastic additives including lubricants, antiblocking agents, release agents, antioxidants, light protecting agents, thermal stabilizers, foam stabilizers, antistatic agents, antifogging additives, slip additives, flame retardants, colorants, effect pigments, optical brighteners, additives for laser marking, impact modifiers, softeners, adhesion promoters, propellants, nucleating agents, clarifiers, acid scavengers, antibacterial additives, antiviral additives, and fungicides,
d) contaminants resulting from the production, preparation, further processing and utilization of the material,
and mixtures thereof.

18. The composition according to claim 12, wherein said calcium silicate hydrate has a BET specific surface area of ≥20 m²/g and wherein said calcium silicate hydrate has a BET specific surface area of ≤800 m²/g.

19. The composition according to claim 12, wherein said calcium silicate hydrate is selected from the group consisting of the crystalline calcium silicate hydrates, xonotlites and tobermorites, and mixtures thereof.

20. The composition according to claim 13, wherein said polysaccharide has a property selected from the group consisting of
a) said polysaccharide has at least partially a helical structure,
b) said polysaccharide has an average molecular weight of more than 10,000 g/mol, and
c) said polysaccharide is starch, a starch derivative, or a mixture thereof.

21. The composition according to claim 13, wherein said adhesion promoter is a functional silane having at least one alkoxy group at each silicon atom.

22. The composition according to claim 13, wherein the adhesion promoter is bonded to the calcium silicate hydrate.

23. A process for producing the composition according to claim 1, comprising the step of
melt-mixing the odor neutralizer with molding compounds of materials made of plastic and other ingredients in an extruder or kneader.

24. The process according to claim 23, wherein components of the odor neutralizer are directly mixed or homogeneously premixed with the material.

25-26. (canceled)
